(19) United States
(12) Patent Application Publication
(10) Pub. No.: US 2016/0005089 A1
(43) Pub. Date: Jan. 7, 2016

(54) INFORMATION PROVISION SYSTEM AND COMPUTER-READABLE RECORDING MEDIUM

(71) Applicant: Atsushi MITSUKI, Tokyo (JP)

(72) Inventor: Atsushi MITSUKI, Tokyo (JP)

(21) Appl. No.: 14/745,911

(22) Filed: Jun. 22, 2015

(30) Foreign Application Priority Data
Jul. 1, 2014 (JP) 2014-136293

(51) Int. Cl. G06Q 30/02

(52) U.S. Cl. CPC G06Q 30/0283

(57) ABSTRACT

A system includes a first acquisition unit, a first generation unit, and a second generation unit. The first acquisition unit acquires usage information representing the user of a function of an electronic apparatus. The first generation unit generates use information on the use of a service using a plurality of electronic apparatuses, on the basis of the usage information. The second generation unit generates provision information that represents a service provision target and that is provided to the service provision target, on the basis of comparison between the use information and a given threshold.

### CROSS-REFERENCE TO RELATED APPLICATIONS

The present application claims priority to and incorporates by reference the entire contents of Japanese Patent Application No. 2014-136293 filed in Japan on Jul. 1, 2014.

### BACKGROUND OF THE INVENTION

1. Field of the Invention

The present invention relates to an information provision system and a computer-readable recording medium.

2. Description of the Related Art

Conventionally, services each assuring maintenance support (of, for example, dealing with failures) for multiple electronic apparatuses, such as image forming apparatuses, and that allow a contractor to use the electronic apparatuses are known. For such a service, in general, a unit cost of the service is set in anticipation of, for example, a charge for maintenance support, a charge for renting the electronic apparatuses, and an additional service charge for, for example, transporting the electronic apparatuses, and the cost of the service is calculated by multiplying the unit cost by the usage of the function of each of the electronic apparatuses (for example, the number of prints in a case where image forming apparatuses are used).

For example, Japanese Laid-open Patent Publication No. 2013-65209 discloses a technology in which, based on supply information containing counter information, such as the number of copies made by an apparatus at a delivery destination, the cost for the apparatus is calculated.

In the above-described service, however, although the unit cost of the service is set in anticipation of a charge for maintenance support, a rental charge for renting the electronic apparatus, and an additional service charge for, for example, transporting the electronic apparatus for the purpose of preventing that the cost from being below with respect to the pre-set unit cost for the service, the cost is below the pre-set unit cost if the contractor (service provision target) hardly uses the electronic apparatus.

In other words, there was no system providing proper use information according to the use of the service (typically, the cost of the service) to the service provision target.

In view of the above-described circumstances, there is a need to provide an information provision system and a computer-readable recording medium that contains a computer program.

### SUMMARY OF THE INVENTION

It is an object of the present invention to at least partially solve the problems in the conventional technology.

According to the present invention, there is provided an information provision system having at least one information processing apparatus, the information provision system comprising: a first acquisition unit that acquires usage information representing the usage of a function of an electronic apparatus; a first generation unit that generates use information on the use of a service using a plurality of electronic apparatuses, on the basis of the usage information; and a second generation unit that generates provision information that represents a service provision target and that is provided to the service provision target, on the basis of comparison between the use information and a given threshold.

The present invention also provides a non-transitory computer-readable recording medium that contains a program that causes a computer to execute: an acquisition step of acquiring usage information representing the usage of a function of an electronic apparatus; a first generation step of generating use information on the use of a service using a plurality of electronic apparatuses, on the basis of the usage information; and a second generation step of generating provision information that represents a service provision target and that is provided to the service provision target, on the basis of comparison between the use information and a given threshold.

The present invention also provides an information provision system having at least one information processing apparatus and an electronic apparatus, the at least one information processing apparatus comprising: a first acquisition unit that acquires, from the electronic apparatus, usage information representing the usage of a function of an electronic apparatus; a first generation unit that generates information on the use of a service using a plurality of electronic apparatuses, on the basis of the usage information acquired by the first acquisition unit; and a second generation unit that generates provision information that represents a service provision target and that is provided to the service provision target, on the basis of comparison between the use information generated by the first generation unit and a given threshold, and the electronic apparatus comprises: a storage unit that stores the usage information representing the usage of the function of the electronic apparatus; and a transmitter that transmits the usage information stored in the storage unit to the information processing apparatus in response to an acquisition request from at least one information processing apparatus from among the at least one information processing apparatus.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of an exemplary configuration of a system according to an embodiment of the present invention;

FIG. 2 is a diagram of an exemplary configuration of a service provision system;

FIG. 3 is a diagram of an exemplary hardware configuration of each of a usage information management apparatus, a contract information management apparatus, and a cost calculation apparatus;

FIG. 4 is a table of exemplary contract information;

FIG. 5 is a diagram for explaining a method of calculating provision information;

FIG. 6 is a diagram of an exemplary bill; and

FIG. 7 is a flowchart of exemplary operations of the cost calculation apparatus.

### DETAILED DESCRIPTION OF THE PREFERRED EMBODIMENTS

With reference to the accompanying drawings, an information provision system and a computer-readable recording medium that contains a computer program according to the invention will be described in detail below.

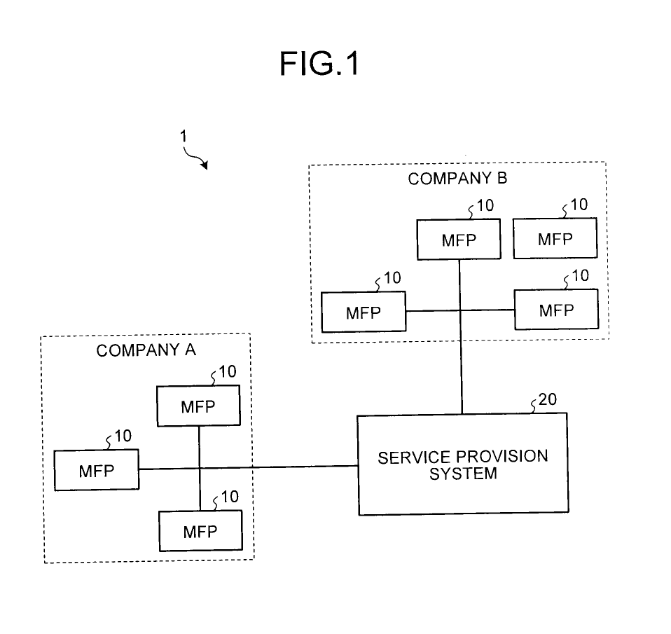

FIG. 1 is a diagram of an exemplary configuration of a system 1 according to an embodiment of the present invention. As shown in FIG. 1, the system 1 includes a service provision system 20 that provides a service using multiple electronic apparatuses (in this example, MFPs 10, but electronic apparatuses are not limited to this) (which may be referred to simply as “service” below); three MFPs 10 that a company A to which the service is provided (service provision target) is allowed to use; and four MFPs 10 that a company B, different from the company A, is allowed to use. In this case, each of the MFPs 10 is communicable with the service provision system 20 via a network, such as the Internet, or is independent of the network. The number of service provision targets (contractors) and the number of MFPs 10 that the service provision target is allowed to use are not limited to those in the example shown in FIG. 1 and they may be changed arbitrarily.

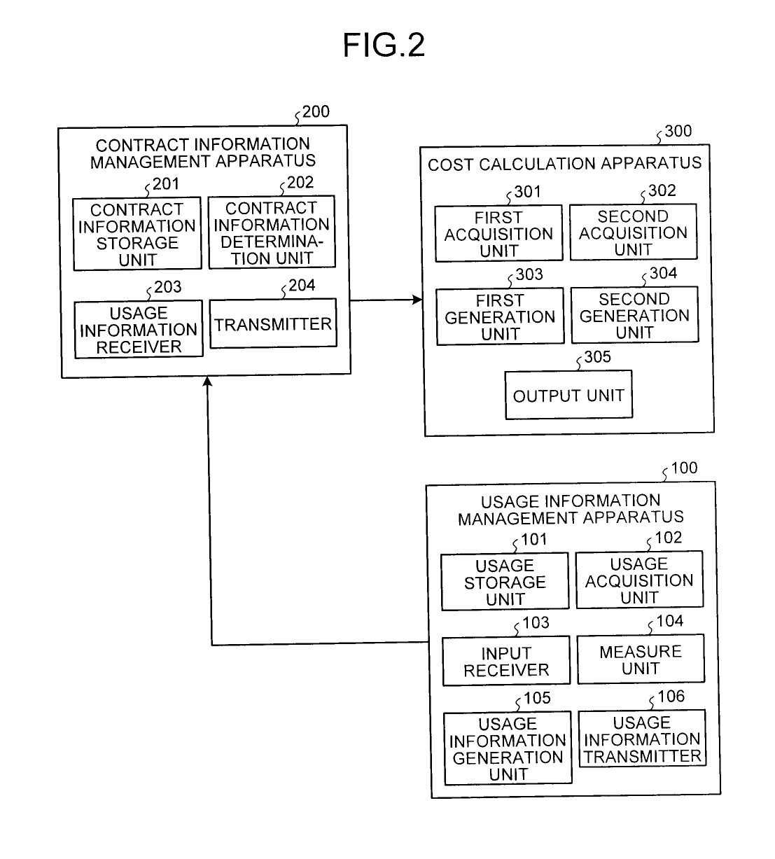

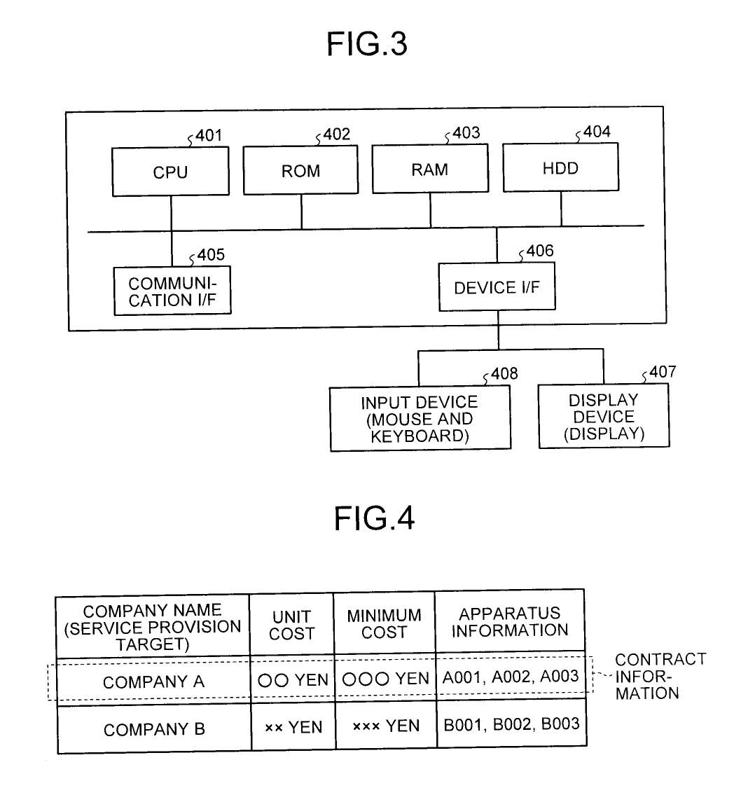

FIG. 2 is a diagram of an exemplary configuration of the service provision system 20. As shown in FIG. 2, the service provision system 20 includes a usage information management apparatus 100, a contract information management apparatus 200, and a cost calculation apparatus 300. FIG. 3 is a diagram of an exemplary hardware configuration of each of the usage information management apparatus 100, the contract information management apparatus 200, and the cost calculation apparatus 300. In this example, each of the usage information management apparatus 100, the contract information management apparatus 200, and the cost calculation apparatus 300 has a hardware configuration of a normal computer apparatus including storage devices, such as a CPU 401, a ROM 402, a RAM 403 and an HDD 404, a communication I/F 405, a device I/F 406, a display device (display) 407 connected to the device I/F 406, and an input device (a mouse and a keyboard) 408. The service provision system 20 can be implemented by using a cloud service or an application service provider (ASP including web services etc.) via a network, such as the Internet, or can be implemented in an environment in which, for example, different groups in the same company are connected via a LAN.

FIG. 2 will be referred back to to continue the explanation. The usage information management apparatus 100 includes a usage storage unit 101, a usage acquisition unit 102, and an input receiver 103, a measure unit 104, a usage information generation unit 105, and a usage information transmitter 106. The usage storage unit 101 manages (stores) usage information representing the usage of the function of the MFP 10. In this example, the usage of the function of the MFP 10 is represented by the number of prints. For example, the usage acquisition unit 102 of the usage information management apparatus 100 may access each MFP 10 via the network to acquire the number of prints made by each MFP 10. For example, if the usage storage unit 101 includes the input receiver 103 and the MFP 10 is not connected to the network, the service person (sales representative) directly may check the number of prints made by the MFP 10 and input the result of the check to the usage information management apparatus 100. The input receiver 103 receives the input from the service person. The usage storage unit 101 manages the usage of each MFP 10 by the service provision target, i.e., the usage of each MFP 10 that the company A is allowed to use and the usage of each MFP 10 that the company B is allowed to use. In this example, the number of prints is used as the usage. Alternatively, depending on the type of electronic apparatuses or the service to be provided, the amount of data communications, the period of use (such as the duration of talk with a videoconference system, the duration of display on a projector, or the duration of running of an electronic board), or the number of times (such as the number of times the projector displays, the number of times support is used, or the number of times a digital camera captures an image) may be used as the usage. As described above, it suffices if the usage be one with which the use of the use of the service can be checked quantitatively.

In this example, the measure unit 104 measures a unit period (e.g., one month) and, each time the time reaches the timing at which a bill charging the cost for the service for the unit period is to be created, the usage information generation unit 105 of the usage information management apparatus 100, for example, causes the usage acquisition unit 102 to access each MFP 10 to acquire the number of prints for the unit period and generates usage information. In this example, it is possible to assume that the usage information is information representing the number of prints made by each MFP 10 for the unit period. The usage information transmitter 106 of the usage information management apparatus 100 transmits the generated usage information to the contract information management apparatus 200.

The contract information management apparatus 200 includes a contract information storage unit 201, a contract information determination unit 202, a usage information receiver 203, and a transmitter 204. The contract information storage unit 201 manages (stores) the contract information. The contract information is information in which a predetermined unit cost of the usage (in this example, the number of prints), the minimum cost representing the minimum cost of the service for the unit period, and the apparatus information representing the MFPs 10 that the service provision target is allowed to use are associated with one another. FIG. 4 is a table of exemplary contract information. In this example, the contract information is separately set for each of the companies A and B that are service provision targets. In this example, the unit cost is previously set in anticipation of, for example, a charge for maintenance support, a rental charge for renting the MFPs 10, and an additional service charge for transporting the MFPs 10 and creating reports.

FIG. 2 will be referred back to to continue the explanation. The usage information receiver 203 of the contract information management apparatus 200 receives the usage information from the usage information management apparatus 100. The contract information determination unit 202 determines the contract information corresponding to the usage information received by the usage information receiver 203 (it is assumed here that the usage information on both of the companies A and B is received) and acquires the contract information corresponding to the company A and the contract information corresponding to the company B from the contract information storage unit 201. The transmitter 204 transmits the usage information and the contract information corresponding to the company A and the contract information corresponding to the company B to the cost calculation apparatus 300.

The cost calculation apparatus 300 calculates the cost of the service for the unit period for each service provision target and creates and outputs a bill charging the calculated cost. In this example, the cost of the service is represented by the spot currency (the currency in this case is yen but, for example, dollar, etc., may be used). Alternatively, for example, the cost may be represented by a currency of electronic money (such as Edy (trademark)) for transaction using electronic data instead of spot currency or of virtual currency (such as Bitcoin (trademark)) using electronic data as currency, by points (such as T-point (trademark)) that are given according to the purchase of products or use of services, or by mileage (trademark).

As shown in FIG. 2, the cost calculation apparatus 300 includes a first acquisition unit 301, a second acquisition unit 302, a first generation unit 303, a second generation unit 304, and an output unit 305.

The first acquisition unit 301 acquires the above-described usage information from the contract information management apparatus 200. The second acquisition unit 302 acquires the above-described contract information from the contract information management apparatus 200. In this example, the second acquisition unit 302 acquires the contract information corresponding to the company A and the contract information corresponding to the company B from the contract information management apparatus 200. Any one of the first acquisition unit 301 and the second acquisition unit 302 may have the function of the other unit.

The first generation unit 303 generates service use information on the basis of the usage information. More specifically, the first generation unit 303 calculates, for each of the MFPs 10 represented by the apparatus information contained in the contract information, an individual use cost representing the cost of the use of the MFP 10 for the unit period by multiplying the number of prints (the number of prints made by the MFP 10 for each unit period) by the unit cost contained in the contract information and calculates, as use information, the total of the individual use costs of the respective MFPs 10 represented by the apparatus information. According to the embodiment, the first generation unit 303 separately generates use information on each of the companies A and B. In this example, the unit cost is represented by the spot currency (in this example, the currency is yen but, for example, dollar, etc. may be used). Alternatively, for example, the cost may be represented by a currency of electronic money (such as Edy (trademark)) for transaction using electronic data instead of spot currency or of virtual currency (such as Bitcoin (trademark)) using electronic data as currency or by points (such as T-point or mileage) that are given according to the purchase of products or use of services.

On the basis of the comparison between the above-described use information and a given threshold, the second generation unit 304 generates provision information to be provided to the service provision target. More specifically, the given threshold represents the minimum cost contained in the above-described contract information. When the use information is below the minimum cost, the second generation unit 304 generates provision information on the basis of the difference between the minimum cost and the use information. More specifically, the second generation unit 304 generates, as provision information, the value of the difference allocated to each of the MFPs 10 according to the number of prints for the unit period made by each of the MFPs 10 represented by the apparatus information contained in the contract information.

According to the embodiment, the second generation unit 304 separately generates provision information on each of the companies A and B. An exemplary case where provision information on the company A is generated will be described below. It is assumed that the unit cost contained in the contract information corresponding to the company A acquired by the first acquisition unit 301 is “2.0 yen”, the minimum cost contained in the contract information is “300,000 yen”, and the apparatus information contained in the contract information represents three MFPs 10 that are identified by model numbers (the numbers for identifying the model) of “A001”, “A002”, and “A003”. Furthermore, it is assumed that, in the usage information acquired by the second acquisition unit 302, the number of prints corresponding to the model number “A001” is “50,000 prints”, the number of prints corresponding to the model number “A002” is “40,000 prints”, and the number of prints corresponding to the model number “A003” is “35,000 prints”.

In the above-described case, as shown in FTC. 5, the individual use cost corresponding to the model number “A001” is calculated as “100,000 yen (=2.0 yen×50,000 prints)”, the individual use cost corresponding to the model number “A002” is calculated as “80,000 yen (=2.0 yen×40,000 prints)”, and the individual use cost corresponding to the model number “A003” is calculated as “70,000 yen (=2.0 yen×35,000)”. Accordingly, the use information on the service provided to the company A amounts to 100,000 yen+80,000 yen+70,000 yen−250,000 yen, which is below the minimum cost (300,000 yen in this case) contained in the contract information corresponding to the company A. Thus, according to the number of prints for the unit period made by each MFP 10, the second generation unit 304 allocates the difference between the minimum cost and the use information (50,000 in this case) to each MFP 10. This will be specifically described below.

In this example, the number of prints corresponding to the model number “A001” is “50,000 prints”, the number of prints corresponding to the model number “A002” is “40,000 prints”, and the number of prints corresponding to the model number “A003” is “35,000 prints”. Accordingly, the total number of prints is 50,000 yen+40,000 yen+35,000 yen=125,000 yen. Because the ratio of the number of prints corresponding to the model number “A001” to the total number of prints is 50,000/125,000=0.4, the second generation unit 304 calculates the value obtained by multiplying “50,000 yen” representing the difference by the ratio of the number of prints corresponding to the model number “A001” to the total number of prints (=50,000 yen×0.4=20,000 yen) as the value allocated to the model number “A001” from among the difference (it is possible to assume that it is provision information corresponding to the model number “A001”).

Similarly, the ratio of the number of prints corresponding to the model number “A002” to the total number of prints is 40,000/125,000=0.32. Thus, the second generation unit 304 calculates the value obtained by multiplying “50,000 yen” representing the difference by the ratio of the number of prints corresponding to the model number “A002” to the total number of prints (=50,000 yen×0.32=16,000 yen) as the value allocated to the model number “A002” from among the difference (it is possible to assume that it is provision information corresponding to the model number “A002”).

Similarly, the ratio of the number of prints corresponding to the model number “A003” to the total number of prints is 35,000/125,000=0.28. Thus, the second generation unit 304 calculates the value obtained by multiplying “50,000 yen” representing the difference by the ratio of the number of prints corresponding to the model number “A003” to the total number of prints (=50,000 yen×0.28=14,000 yen) as the value allocated to the model number “A003” from among the difference (it is possible to assume that it is provision information corresponding to the model number “A003”).

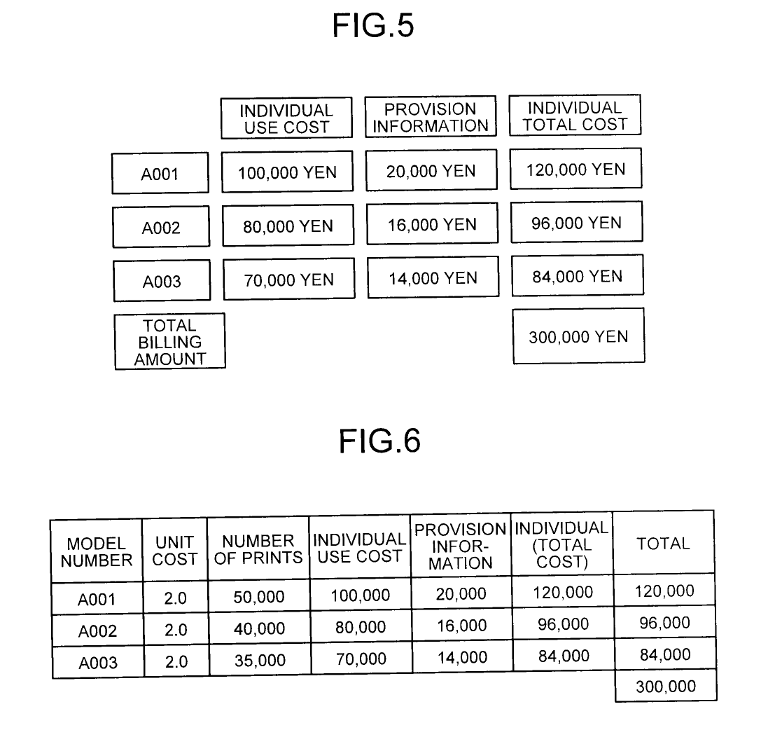

The second generation unit 304 calculates an individual total cost by summing the individual use cost and the provision information for each MFP 10. In the example shown in FIG. 5, the individual total cost corresponding to the model number “A001” is calculated as 100,000 yen+20,000 yen=120,000 yen, the individual total cost corresponding to the model number “A002” is calculated as 80,000 yen+16,000 yen=96,000 yen, and the individual total cost corresponding to the model number “A003” is calculated as 70,000 yen+14,000 yen=84,000 yen.

The second generation unit 304 calculates the total of individual total costs as the total billing amount representing the total charge for the service provided to the company A for the unit period. In the example shown in FIG. 4, the total billing amount is 120,000 yen+96,000 yen+84,000 yen=300,000 yen.

In this example, the second generation unit 304 creates a bill representing the total billing amount and the details of the total billing amount. FIG. 6 is a diagram of an exemplary bill to the company A in the above-described case. When the use information is equal to or larger than the minimum cost, processing for generating (calculating) provision information is not performed and the details of the total billing amount does not at least contain the item of “provision information”.

In this manner, the second generation unit 304 creates a bill to each service provision target. The bill created by the second generation unit 304 is sent to the output unit 305. The output unit 305 outputs the bill created by the second generation unit 304. Any mode of output can be employed. For example, the output unit 305 may transmit a bill to a service provision target to a mail address of a management PC of the service provision target or a printer (not shown) may be caused to print out the bill. Alternatively, the created bill may be transmitted to an external apparatus (such as a server). In this mode, for example, the external apparatus may transmit the bill to the service provision target to the mail address of the management PC of the service provision target or the printer (not shown) may be caused to print out the bill.

In this example, the second generation unit 304 creates bills. Alternatively, the output unit 305 may create bills. Alternatively, for example, the second generation unit 304 may have the function of the output unit 305.

According to the embodiment, the functions of the respective units of the above-described cost calculation apparatus 300 (the first acquisition unit 301, the second acquisition unit 302, the first generation unit 303, the second generation unit 304, and the output unit 305) are implemented in a way that the CPU 401 of the cost calculation apparatus 300 loads a program stored in, for example, the ROM 402 to the RAM and executes the program. Alternatively, for example, the functions of the respective units of the cost calculation apparatus 300 may be at least partly implemented with a dedicated hardware circuit (such as a semiconductor integrated circuit).

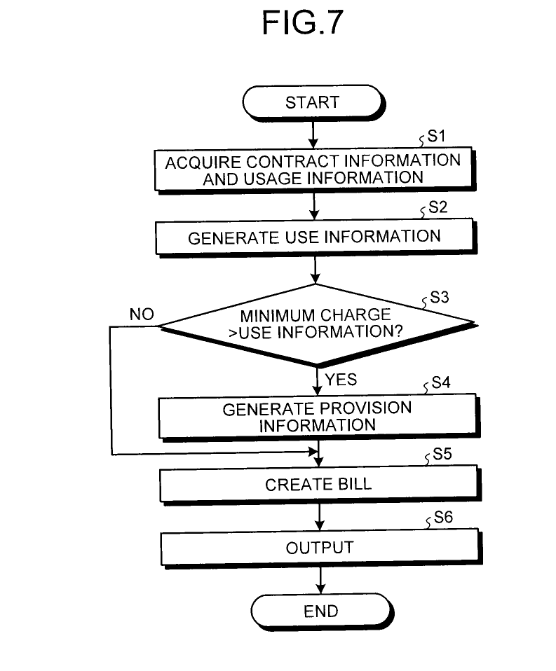

FIG. 7 is a flowchart of exemplary operations of the cost calculation apparatus 300. The exemplary operations from creation of a bill to the company A to output of the bill will be described. As shown in FIG. 6, the first acquisition unit 301 acquires the usage information and the second acquisition unit 302 acquires the contract information corresponding to the company A (step S1). The first generation unit 303 then generates the use information on the company A by using the usage information and the contract information corresponding to the company A (step S2). The second generation unit 304 then determines whether or not the minimum cost contained in the contract information corresponding to the company A is above the use information generated at step S2 (step S3). When the minimum cost is above the use information (YES at step S3), the second generation unit 304 generates the provision information (step S4). The second generation unit 304 creates the bill to the company A (step S5). On the other hand, when the minimum cost is equal to or below the use information (NO at step S3), the second generation unit 304 does not perform the processing for creating the provision information and creates the bill (step S5). The output unit 305 then outputs the bill created at step S5 (step S6).

As described above, according to the embodiment, the provision information to be provided to the service provision target is generated on the basis of the comparison between the use information and the given threshold (in this case, the minimum cost). More specifically, according to the embodiment, when the use information is below the minimum cost, the value of the difference between the minimum cost and the use information allocated to each of the MFPs 10 according to the number of prints for the unit period made by each of the MFPs 10 represented by the apparatus information contained in the contract information is generated as provision information. Because a bill representing the provision information is created, for example, even when different sections in the service provision target pay for the respective MFPs 10 that are used, it is unnecessary to calculate the charge know which section pays for the charge and which ratio to the difference the section pays. Thus, according to the embodiment, an advantageous effect that it is possible to reduce the load on the service provision target.

Modifications will be described below.

(1) Modification 1 For example, when the use information is below the minimum cost, the second generation unit 304 may generate the difference between the minimum cost and the use information as provision information. In this mode, when a bill is crated, a row representing the difference is added.

Modification 2

According to the embodiment, the contract information management apparatus 200 integrates the usage information and the contract information and transmits the integrated information to the cost calculation apparatus 300. Alternatively, for example, the usage information management apparatus 100 may directly transmit the usage information to the cost calculation apparatus 300. Alternatively, in addition to the usage information management apparatus 100 and the contract information management apparatus 200, an apparatus that integrates usage information and contract information may be provided and the apparatus may transmit the integrated information from the usage information and the contract information to the cost calculation apparatus 300.

Alternatively, without provision of the usage information management apparatus 100, the first acquisition unit 301 may have the function of the usage information management apparatus 100. Similarly, without provision of the contract information management apparatus 200, the second acquisition unit 302 may have the function of the contract information management apparatus 200. In short, it suffices if the service provision system 20 is configured of at least one information processing apparatus, i.e., the service provision system 20 may be configured of one information processing apparatus or may be configured of multiple information processing apparatuses.

According to the embodiment, the example has been described where the electronic apparatuses are the image forming apparatuses represented by MFP. The image forming apparatuses include, for example, in addition to MFPs, laser printers (LP), facsimile machines, and scanners. For example, the electronic apparatuses may be other than image forming apparatuses, i.e., may be projectors, videoconference systems, digital cameras, or electronic boards. An electronic apparatus to which the invention is applied may include at least a storage unit that stores use information representing the usage of the function of the electronic apparatus and a transmitter that transmits use information stored in the storage unit to the information processing apparatus in response to an acquisition request from at least one of at least one information processing apparatus.

In this example, it can be assumed that the service provision system 20 corresponds to the “information provision system” according to the claims. It can be also assumed that the system 1 including the MFPs 10 corresponds to the “information provision system” according to the claims. In this example, it can be also assumed that the cost calculation apparatus 300 corresponds to the “information provision apparatus” according to the claims.

(3) Modification 3

According to the embodiment, the unit cost contained in the contract information is set at the same value between the MFPs 10. Alternatively, the unit cost may vary according to the model. For example, the unit cost may vary according to the printing mode of, for example, monochrome printing or color printing.

The above-described embodiment and modifications may be arbitrarily combined.

Computer-Readable Recording Medium Containing a Program

The program executed by the service provision system 20 may be recorded in a computer-readable recording medium, such as a CD-ROM, a flexible disk (FD), a CD-R, a digital versatile disk (DVD), or a universal serial bus (USB), in a form of an installable or executable file, or may be provided or distributed via a network, such as the Internet. Alternatively, various programs may be provided in a way that they are previously installed in a non-volatile recording medium, such as a ROM.

According to the embodiment, it is possible to provide proper use information corresponding to the use of the service.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information provision system having at least one information processing apparatus, the information provision system comprising:
a first acquisition unit that acquires usage information representing the usage of a function of an electronic apparatus;
a first generation unit that generates use information on the use of a service using a plurality of electronic apparatuses, on the basis of the usage information; and
a second generation unit that generates provision information that represents a service provision target and that is provided to the service provision target, on the basis of comparison between the use information and a given threshold.

2. The information provision system according to claim 1, further comprising a second acquisition unit that acquires contract information in which a predetermined unit cost of the usage, a minimum cost representing a minimum cost of the service for a unit period, and apparatus information representing the electronic apparatuses that the service provision target is allowed to use are associated with one another,
wherein
the given threshold represents the minimum cost,
the first generation unit calculates, for each of the electronic apparatuses represented by the apparatus information, an individual use cost representing a cost of the use of the electronic apparatus for the unit period by multiplying the usage for the unit period by the unit cost contained in the contract information and calculates, as the use information, a total of the individual use costs of the respective electronic apparatuses represented by the apparatus information, and
when the use information is below the minimum cost, the second generation unit generates the provision information on the basis of the difference between the minimum cost and the use information.

3. The information provision system according to claim 2, wherein the second generation unit generates, as the provision information, the value of the difference allocated to each of the electronic apparatuses according to the usage for the unit period at each of the electronic apparatuses represented by the apparatus information.

4. The information provision system according to claim 2, wherein the second generation unit generates the difference as the provision information.

5. The information provision system according to claim 1, wherein
the electronic apparatus is an image forming apparatus, and
the usage represents the number of prints.

6. A non-transitory computer-readable recording medium that contains a program that causes a computer to execute:
an acquisition step of acquiring usage information representing the usage of a function of an electronic apparatus;
a first generation step of generating use information on the use of a service using a plurality of electronic apparatuses, on the basis of the usage information; and
a second generation step of generating provision information that represents a service provision target and that is provided to the service provision target, on the basis of comparison between the use information and a given threshold.

7. The non-transitory computer-readable recording medium according to claim 6, the program further executes a second acquisition step of acquiring contract information in which a predetermined unit cost of the usage, a minimum cost representing a minimum cost of the service for a unit period, and apparatus information representing the electronic apparatuses that the service provision target is allowed to use are associated with one another,
wherein
the given threshold represents the minimum cost,
in the first generation step, there is calculated, for each of the electronic apparatuses represented by the apparatus information, an individual use cost representing a cost of the use of the electronic apparatus for the unit period by multiplying the usage for the unit period by the unit cost contained in the contract information and is calculated, as the use information, a total of the individual use costs of the respective electronic apparatuses represented by the apparatus information, and
when the use information is below the minimum cost, in the second generation step, there is generated the provision information on the basis of the difference between the minimum cost and the use information.

8. The non-transitory computer-readable recording medium according to claim 7, wherein, in the second generation step, there is generated, as the provision information, the value of the difference allocated to each of the electronic apparatuses according to the usage for the unit period at each of the electronic apparatuses represented by the apparatus information.

9. The non-transitory computer-readable recording medium according to claim 7, wherein, in the second generation step, there is generated the difference as the provision information.

10. The non-transitory computer-readable recording medium according to claim 6, wherein
the electronic apparatus is an image forming apparatus, and
the usage represents the number of prints.

11. An information provision system having at least one information processing apparatus and an electronic apparatus,
the at least one information processing apparatus comprising:
a first acquisition unit that acquires, from the electronic apparatus, usage information representing the usage of a function of an electronic apparatus;
a first generation unit that generates information on the use of a service using a plurality of electronic apparatuses, on the basis of the usage information acquired by the first acquisition unit; and
a second generation unit that generates provision information that represents a service provision target and that is provided to the service provision target, on the basis of comparison between the use information generated by the first generation unit and a given threshold, and
the electronic apparatus comprises:
a storage unit that stores the usage information representing the usage of the function of the electronic apparatus; and
a transmitter that transmits the usage information stored in the storage unit to the information processing apparatus in response to an acquisition request from at least one information processing apparatus from among the at least one information processing apparatus.

12. The information provision system according to claim 11, the at least one information processing apparatus further comprising a second acquisition unit that acquires contract information in which a predetermined unit cost of the usage, a minimum cost representing a minimum cost of the service for a unit period, and apparatus information representing the electronic apparatuses that the service provision target is allowed to use are associated with one another,
wherein
the given threshold represents the minimum cost,
the first generation unit calculates, for each of the electronic apparatuses represented by the apparatus information, an individual use cost representing a cost of the use of the electronic apparatus for the unit period by multiplying the usage for the unit period by the unit cost contained in the contract information and calculates, as the use information, a total of the individual use costs of the respective electronic apparatuses represented by the apparatus information, and
when the use information is below the minimum cost, the second generation unit generates the provision information on the basis of the difference between the minimum cost and the use information.

13. The information provision system according to claim 12, wherein the second generation unit generates, as the provision information, the value of the difference allocated to each of the electronic apparatuses according to the usage for the unit period at each of the electronic apparatuses represented by the apparatus information.

14. The information provision system according to claim 12, wherein the second generation unit generates the difference as the provision information.

15. The information provision system according to claim 11, wherein
the electronic apparatus is an image forming apparatus, and
the usage represents the number of prints.
